(19) United States
(12) Patent Application Publication
(10) Pub. No.: US 2005/0205207 A1
(43) Pub. Date: Sep. 22, 2005

(54) Polishing apparatus and method for manufacturing semiconductor device

(76) Inventors: Gaku Minamihaba, Yokohama-shi (JP); Hiroyuki Yano, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/023,599

(22) Filed: Dec. 29, 2004

(30) Foreign Application Priority Data
Mar. 19, 2004 (JP) 2004-080812

(51) Int. Cl. B44C 1/22

(52) U.S. Cl. 156/345.12; 216/88; 216/89; 438/692

(57) ABSTRACT

Disclosed is a polishing apparatus comprising a rotating mechanism which rotates a semiconductor substrate having a treatable film deposited thereon, and a supply unit which supplies a chemical liquid to a polishing surface of the treatable film, the supply unit having an abrasive grain injection nozzle, an additive supply port, and a water supply port and being able to spray the chemical liquid onto at least one of the surfaces including the top surface, side surface, and bottom surface of the semiconductor substrate.

### CROSS-REFERENCE TO RELATED APPLICATIONS

This application is based upon and claims the benefit of priority from prior Japanese Patent Application No. 2004-080812, filed Mar. 19, 2004, the entire contents of which are incorporated herein by reference.

### BACKGROUND OF THE INVENTION

1. Field of the Invention

This invention relates to a polishing apparatus and a method of manufacturing a semiconductor device, and in particular to a polishing apparatus and a method of manufacturing a semiconductor device, wherein a multi-injection nozzle is employed.

2. Description of the Related Art

In the process of manufacturing a semiconductor device, not only the top surface of a semiconductor substrate, but also any other optional surfaces such as the side surface or bottom surface are essentially required to be worked (polished). Up to date, a method of selectively polishing the side surface of a semiconductor substrate or a method of selectively polishing the bottom surface of a semiconductor substrate has been proposed.

As long as the film to be treated is of the same kind, the polishing of film to be treated (hereinafter referred to as a treatable film) which is formed on each of the surfaces is performed at present by using an apparatus separately assigned to each of the surfaces even if the polishing of the films on all of these surfaces is performed by the same procedure. As the size of semiconductor substrates is increased to 200 mm in diameter or still more to 300 mm in diameter, the polishing apparatus is required to be made correspondingly larger, thus requiring an increase in floor space for the polishing apparatus. Therefore, the CR (clean room) is also required to be constructed larger, resulting in an increase in manufacturing cost.

On the other hand, when Cu damascene wiring is to be formed by using a low dielectric constant insulating film (low-k film) such as a porous insulating film, it is required, in order to secure high reliability, to inhibit the peeling or erosion of the low-k film as much as possible. There are possibilities that Cu runs around over the side surface or bottom surface of the semiconductor substrate when depositing a Cu film. There are also possibilities when depositing a low-k film that the low-k film runs around over a region of another surface where the deposition of the low-k film is not desirable. Once this undesirable deposition of Cu film or low-k film has take place, such a redundant portion of Cu film or low-k film is required to be removed. Therefore, in view of the aforementioned reasons in particular, it is desirable that the removal of these redundant films is performed by using a single-unit polishing apparatus.

### BRIEF SUMMARY OF THE INVENTION

A polishing apparatus according to one aspect of the present invention comprises a rotating mechanism which rotates a semiconductor substrate having a treatable film deposited thereon; and a supply unit which supplies a chemical liquid to a polishing surface of the treatable film, the supply unit having an abrasive grain injection nozzle, an additive supply port, and a water supply port and being able to spray the chemical liquid onto at least one of the surfaces including the top surface, side surface, and bottom surface of the semiconductor substrate.

A method for manufacturing a semiconductor device according to another aspect of the present invention comprises forming an insulating film above a semiconductor substrate; forming a recessed portion in the insulating film; depositing a conductive material in the recessed portion and on the insulating film to form a conductive layer; and removing part of the conductive material which is deposited on the insulating film to expose the surface of the insulating film while leaving the conductive material in the recessed portion, the removal of the conductive material deposited on the insulating film being performed by using a supply unit which is provided with an abrasive grain injection nozzle, an additive supply port, and a water supply port, the supply unit being directed to face a polishing surface of the conductive layer and, while keeping the semiconductor substrate rotated, by injecting abrasive grain from the abrasive grain injection nozzle and at least an oxidizing agent from the additive supply port to the polishing surface to polish the conductive material, and by spraying water from the water supply port onto the polishing surface after finishing the polishing to wash the polishing surface.

A method for manufacturing a semiconductor device according to another aspect of the present invention comprises forming an insulating film at least above a top surface and side surface of a semiconductor substrate; and removing part of the insulating film which is deposited on a region other than the top surface of the semiconductor substrate, the removal of the insulating film being performed by using a supply unit which is provided with an abrasive grain injection nozzle, an additive supply port, and a water supply port, the supply unit being directed to face a polishing surface of the insulating film and, while keeping the semiconductor substrate rotated, by injecting abrasive grain from the abrasive grain injection nozzle and a surfactant from the additive supply port to the polishing surface to polish the insulating film, and by spraying water from the water supply port onto the polishing surface after finishing the polishing to wash the polishing surface.

### BRIEF DESCRIPTION OF THE SEVERAL VIEWS OF THE DRAWING

FIG. 1 is a schematic perspective view representing a polishing apparatus according to one embodiment of the present invention;

FIG. 2 is a schematic perspective view illustrating the supply of chemical liquid by using a polishing apparatus according to one embodiment of the present invention;

FIG. 3 is a schematic perspective view representing a polishing apparatus according to another embodiment of the present invention;

FIG. 4 is a schematic perspective view representing a polishing apparatus according to a further embodiment of the present invention;

FIG. 5 is a schematic perspective view representing a polishing apparatus according to a further embodiment of the present invention;

FIGS. 6A and 6B are cross-sectional views each representing the steps of manufacturing method of a semiconductor device according to one embodiment of the present invention;

FIGS. 7A and 7B are cross-sectional views each illustrating macroscopically one embodiment of the semiconductor substrate; and

FIGS. 8A and 8B are cross-sectional views each illustrating macroscopically another embodiment of the semiconductor substrate.

### DETAILED DESCRIPTION OF THE INVENTION

Next, various embodiments of the present invention will be explained with reference to drawings.

FIG. 1 illustrates the construction of a polishing apparatus according to one embodiment of the present invention.

As shown in FIG. 1, the polishing apparatus according to this embodiment of the present invention comprises rollers 11a, 11b and 11c constituting a rotating mechanism for rotating a semiconductor substrate 10 having a treatable film (i.e., a film to be treated) (not shown) deposited thereon, and a supply unit 12 for spraying a chemical liquid onto a polishing surface (i.e., a surface to be polished) of the treatable film. The number of the rollers in the rotating mechanism is not limited to three as shown in FIG. 1, but may be suitably adjusted if required. It is preferable to control the rotational speed of the rollers 11a, 11b and 11c during the polishing process so as to make the effective rotational speed of the semiconductor substrate 10 become about 5 to 200 rpm. Further, in the case where a drying step is included in the polishing process, it is preferable to construct the rotating mechanism so as to enable the rollers 11a, 11b and 11c to rotate at a rotational speed of 1000 rpm or more. If the effective rotational speed of the semiconductor substrate 10 is lower than 5 rpm, non-uniformity in supply of the chemical liquid onto the polishing surface may occur. On the other hand, if the effective rotational speed of the semiconductor substrate 10 is higher than 200 rpm, it may not be possible to supply a required quantity of an additive due to an excessive magnitude of centrifugal force. In either case, the washing power, polishing speed and in-plane uniformity of polishing may deteriorate in the polishing process. Since the polishing is performed while keeping the rotation of semiconductor substrate 10 as described above, it is possible to achieve a practical polishing speed and a high washing power.

The supply unit 12 is constituted by an abrasive grain injection nozzle 13, an additive supply port 14, and a water supply port 15. This supply unit 12 is made movable by an arm (not shown), so that it can be disposed to face any desired surface such as the top surface, side surface or bottom surface of the semiconductor substrate 10. Therefore, the polishing of a polishing surface of treatable film formed on the semiconductor substrate can be performed by injecting abrasive grain from the abrasive grain injection nozzle 13 to the polishing surface and at the same time, spraying an additive such as an oxidizing agent or a surfactant from the additive supply port 14 to the polishing surface. After finishing the polishing, water is sprayed from the water supply port 15 onto the polishing surface to wash the polished surface. As a result, it is now possible to perform the polishing of a treatable film existing on any surface of the semiconductor substrate such as the top surface, side surface or bottom surface thereof by using the polishing apparatus according to this embodiment of the present invention.

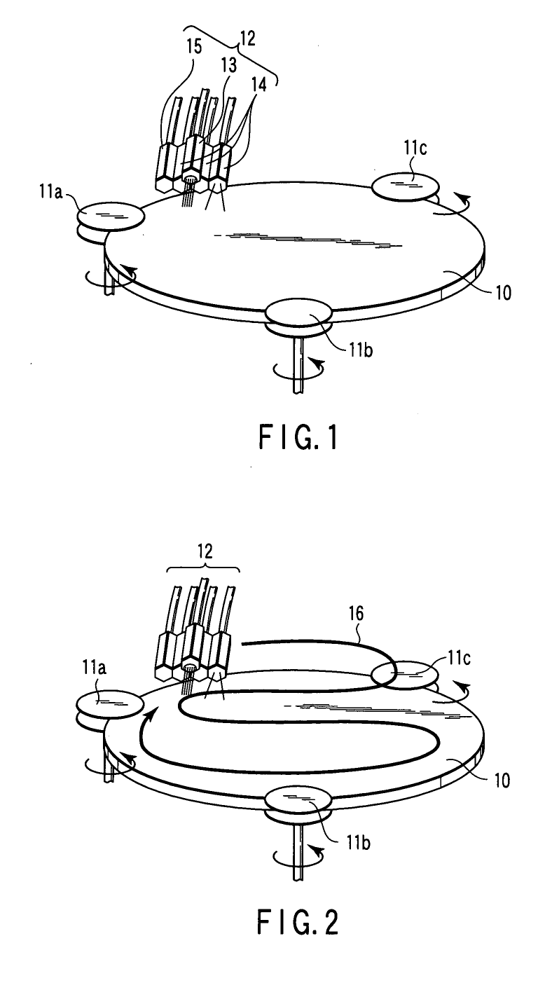

If the supply unit 12 is to be positioned so as to direct it to face the top surface or bottom surface of the semiconductor substrate 10, the supply unit 12 should preferably be made meanderingly movable over the semiconductor substrate 10 along a track 16 as shown in FIG. 2 in order to enable the abrasive grain, etc. to be supplied the entire surface of the treatable film. The moving velocity of the supply unit 12 should preferably be confined within the range of 1 to 20 mm/sec. If this moving velocity is lower than 1 mm/sec, non-uniformity in supply of the chemical liquid onto the polishing surface may occur, thereby degrading the washing power, polishing speed and in-plane uniformity of polishing in the polishing process. On the other hand, even if the supply unit 12 is moved at an increased velocity of higher than 20 mm/sec, it would be impossible to expect any improvement in polishing performance. Rather, since such a high moving velocity of the supply unit 12 would impose an excessive load on the polishing apparatus, it may cause the damage of the polishing apparatus. If the polishing apparatus is damaged in this manner, the operation rate of the polishing apparatus would be degrading, thus giving much influence to the mass production of the semiconductor device.

On the other hand, the supply unit 12 is positioned so as to face the side surface of the semiconductor substrate 10, the supply unit 12 may not necessarily be rendered movable. However, when the supply unit 12 moves up and down at a velocity of about 1 to 10 mm/sec, damages to the semiconductor substrate, if any, can be minimized and at the same time, the uniformity of polishing can be improved, thus making it possible to enhance the polishing performance.

The opening diameter of the abrasive grain injection nozzle 13 should preferably be confined within the range of about 0.5 to 5 mm. If the opening diameter of the abrasive grain injection nozzle 13 is smaller than 0.5 mm, the clogging of the injection nozzle 13 due to the abrasive grain may occur. On the other hand, if the opening diameter of the abrasive grain injection nozzle 13 is larger than 5 mm, it may become difficult to realize a practical polishing speed. Further, if the abrasive grain injection nozzle 13 is directed to the top surface or bottom surface of the semiconductor substrate, the abrasive grain injection nozzle 13 should preferably be disposed in such a manner that the central axis thereof is inclined at an angle ranging from 10° to 45° to a target polishing region of the polishing surface and that the distal end thereof is spaced away from a target polishing region of the polishing surface by a distance ranging from about 1 to 20 mm. If the inclination angle of the abrasive grain injection nozzle 13 is less than 10°, it may become difficult to realize a practical polishing speed. On the other hand, if the inclination angle of the abrasive grain injection nozzle 13 is larger than 45°, various problems such as the generation of erosion or increasing possibility of damaging the semiconductor substrate may occur. Further, if the distance between the distal end of the injection nozzle 13 and the target polishing region is less than 1 mm, there may be a risk of contact between the distal end of the injection nozzle 13 and the semiconductor substrate. On the other hand, if this distance is increased beyond 20 mm, the polishing speed may deteriorate.

It is preferable to confine the injection pressure of the abrasive grain to be delivered from the injection nozzle 13 to the range of about 1 to 20 kg/cm². If the injection pressure of the abrasive grain is less than 1 kg/cm², it may become difficult to secure a sufficient polishing power. On the other hand, if the injection pressure of the abrasive grain is larger than 20 kg/cm², it may give rise to damaging to the semiconductor substrate.

The abrasive grain can be suitably selected depending on the kinds of the treatable film. More specifically, the abrasive grain can be selected from inorganic particles such as colloidal silica, fumed alumina, titania, zirconia, ceria, etc.; organic particles such as polyvinyl chloride, polystyrene, styrene copolymer, (metha)acrylic resin (such as polymethyl methacryalte), acrylic copolymer, etc.; and inorganic/organic composite particles comprising these inorganic and organic particles.

The abrasive grain can be employed as a slurry by dispersing it in a dispersion medium such as water at a concentration of about 0.1 to 30 wt % for instance. In this case, the abrasive grain injection nozzle 13 may be called a slurry injection nozzle. If the concentration of the abrasive grain in the slurry is less than 0.1 wt %, it may become difficult to secure a sufficient polishing speed. On the other hand, if the concentration of the abrasive grain in the slurry is higher than 30 wt %, various problems such as the generation of erosion, increased possibility of damaging to the semiconductor substrate or an increase in manufacturing cost of slurry may occur.

Under some circumstances, the abrasive grain may be employed as it is without dispersing it in a dispersion medium such as water. In this case, the abrasive grain should preferably be employed at a ratio ranging from about 0.1 to 30 wt % based on a total quantity of the entire chemical liquids to be supplied to the polishing surface. If the ratio of the abrasive grain is less than 0.1 wt %, it would be impossible to perform satisfactory polishing due to the shortage of the abrasive grain. On the other hand, if the ratio of the abrasive grain is larger than 30 wt %, various problems such as the generation of erosion, increased possibility of damage to the semiconductor substrate or an increase in manufacturing cost of abrasive grain may occur.

The primary particle diameter of the abrasive grain may range from 10 to 1000 nm. As long as the primary particle diameter of the abrasive grain is confined within this range, it may be possible to employ a mixture comprising two or more kinds of abrasive grains each kind differing in the range of primary particle diameter. The primary particle diameter of the abrasive grain can be calculated through TEM observation for example. Since a hard insulating film for example can be polished at a high speed, it is preferable to employ abrasive grain having a primary particle diameter ranging from 30 to 500 nm for the polishing of the side surface and bottom surface of the semiconductor substrate 10. Further, since the surface roughness Ra of the polishing surface (the top surface of the semiconductor substrate 10) is required to be at least 100 nm or less, more preferably 10 nm or less, it is preferable to employ abrasive grain having a primary particle diameter ranging from 10 to 100 nm or a mixture of such abrasive grains for the polishing of the top surface of the semiconductor substrate 10.

As for the additive to be supplied from the additive supply port 14, it is possible to employ an oxidizing agent, a surfactant, an oxidation-suppressing agent, a polishing-promoting agent, a pH controlling agent, a washing solution, etc. If required, it is possible to employ two or more kinds of additives. If two or more kinds of additives are employed, the number of the additive supply port may be suitably increased. For example, if the treatable film is constituted by a conductive film such as a Cu film and a Ta film, it is possible to employ an oxidizing agent, an oxidation-suppressing agent or a surfactant as an additive. If the treatable film is constituted by an insulating film such as an SiN film, it is possible to employ a surfactant as an additive.

As for the oxidizing agent, it is possible to employ ammonium persulfate, potassium persulfate, ferric nitrate, diammonium cerium nitrate, silicomolybdic acid, hydrogen peroxide, etc. As for the surfactant, it is possible to employ anionic surfactants such as potassium dodecylbenzene sulfonate, perfluoroalkyl carbonate (anion), etc.; cationic surfactants such as dodecyl amine hydrochloride, dodecyl pyridinium chloride, etc.; and nonionic surfactants such as perfluoroalkyl ethylene oxide (EO) adducts, acetylene diol, polyethylene glycol monolaurate, polyoxyethylene derivatives, etc. As for the oxidation-suppressing agent, it is possible to employ quinaldinic acid, quinolinic acid, 7-hydroxy-5-methyl-1,3,4-triazaindolizine, BTA (benzotriazole), etc. As for the polishing-promoting agent, it is possible to employ glycine, alanine, malic acid, maleic acid, lactic acid, malonic acid, etc. As for the pH controlling agent, it is possible to employ KOH, ammonia, ethylene diamine, nitric acid, hydrochloric acid, phosphoric acid, etc. As for the washing solution, it is possible to employ citric acid, oxalic acid, etc. if an organic acid is to be employed.

Irrespective of the kinds of additive to be employed, the feeding rate (flow rate) of the additive from the additive supply port 14 should preferably be confined within the range of 10 to 1000 cc/min. If the flow rate of the additive is less than 10 cc/min, non-uniformity in supply of the additive onto the polishing surface may generate, thereby giving rise to the deterioration of washing power, polishing speed and in-plane uniformity of polishing in the polishing process. Incidentally, since the performance of polishing and washing would be saturated when the supply of additives reaches to 1000 cc/min or so, the supply of additive exceeding this flow rate of 1000 cc/min would be useless, simply giving rise to an increase in manufacturing cost of the additives.

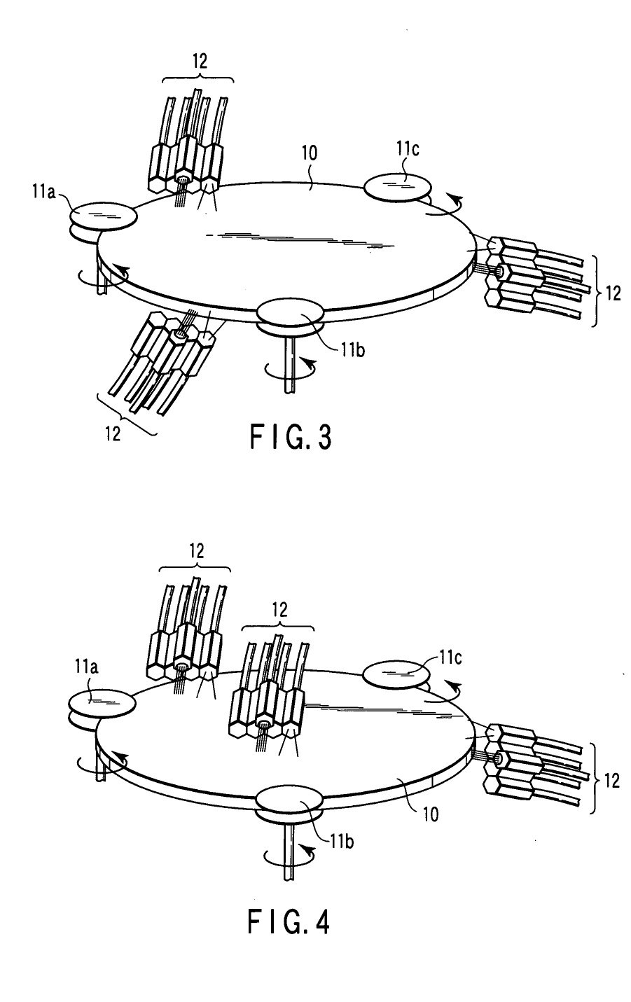

The number of the supply unit 12 may not be limited to only one, but may be two or more. For example, as shown in FIG. 3, three units of the supply unit may be employed, thus enabling them to be disposed to face the top surface, side surface and bottom surface of the semiconductor substrate 10, respectively. In this case, it is possible to concurrently polish three different faces of the semiconductor substrate, thereby greatly reducing the treating time. Because of the reasons explained above, it is preferable that the supply unit 12 which is disposed to face the top surface or the bottom surface of the semiconductor substrate is meanderingly movable at a predetermined velocity. Alternatively, as shown in FIG. 4, two units out of three supply units may be disposed to face the top surface of the semiconductor substrate, the remainder being disposed to face the side surface of the semiconductor substrate. This arrangement would make it possible to enhance the treating efficiency of the polishing surfaces. Under some circumstances, all of three supply units may be concentratedly directed to any one of these surfaces.

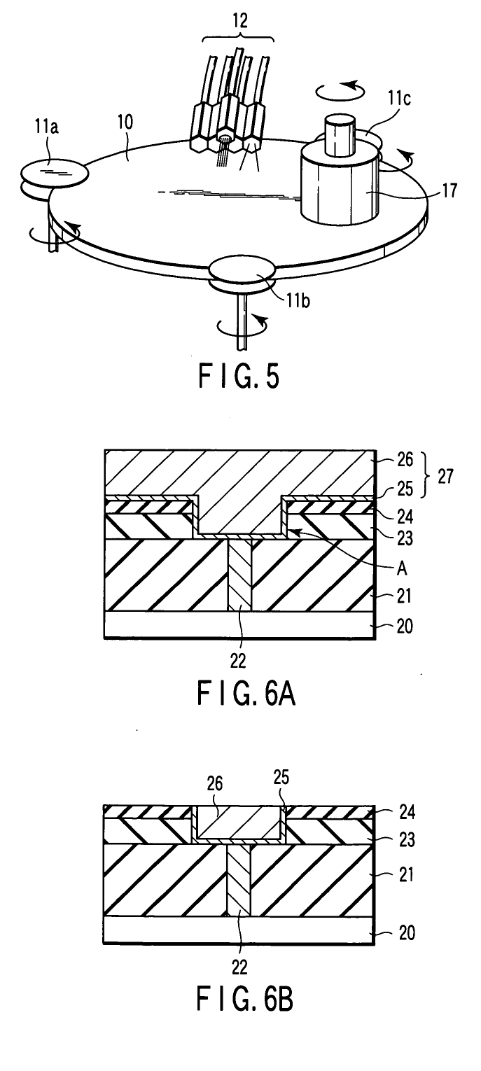

As described above, by polishing the treatable film of the semiconductor substrate by supplying an additive thereto from the additive supply port while injecting abrasive grain-from the abrasive grain injection nozzle, it is possible to secure a certain degree of morphology. If the polishing surface is desired to be finished more finely after the polishing treatment, it is preferable to dispose a polishing head 17 which is enabled to contact with the surface of the semiconductor substrate 10 as shown in FIG. 5. Incidentally, when the supply unit 12 is disposed to face not only the top surface of the semiconductor substrate 10 but also the bottom surface of the semiconductor substrate 10, the polishing head 17 should preferably be disposed correspondingly. This polishing head 17 can be configured such that it is movable over the polishing surface by an arm (not shown) and that it is capable of rocking from the center of the semiconductor substrate 10 to the periphery of the semiconductor substrate 10 at a velocity ranging from about 1 to 10 mm/sec while rotating the polishing head 17 at a rotational speed of 5 to 300 rpm. Additionally, it is preferable in view of enhancing the functionality that the polishing head 17 is as small as 10 to 50 mm in diameter. It is also preferable that the polishing head 17 is provided with a polishing cloth or brush which is adhered onto the abrasive surface thereof.

As for the polishing cloth, it is possible to employ IC1000, Politex (Rodel Nitta Co., Ltd.). As for the materials for the brush, it is possible to employ polyvinyl chloride, nylon or polypropylene. It is preferable that the thickness (diameter) of the tip of the filling is confined to 30 μm or less. In this case, the surface roughness generated when the filling of brush is pressed en block onto the polishing surface is considered to correspond to the roughness of the surface of the conventional polishing cloth, thereby making it possible to perform very fine polishing.

Although the polishing head 17 can be contacted with the polishing surface at a load confined within the range of 10 to 300 gf/cm², it is more preferable, for the purpose of suppressing the peeling of the treatable film, to make the polishing head 17 contact with the polishing surface at a load of as low as not more than 200 gf/cm².

The polishing with the assistance of the polishing head 17 can be performed simultaneous with the feeding of a chemical liquid from the supply unit 12 onto the polishing surface. Alternatively, the polishing head may be employed for the finishing work such as touch-up after finishing the most of polishing work of the treatable film.

In the employment of the polishing apparatus according to one aspect of the present invention, the polishing of a treatable film can be performed by injecting abrasive grain from the abrasive grain injection nozzle of the supply unit and also by feeding an additive from the additive supply port to the polishing surface while keeping the rotation of the semiconductor substrate having the treatable film formed thereon. The supply unit can be disposed to face any desired surface of the semiconductor substrate, so that by using the polishing apparatus according to one aspect of the present invention, it is possible to polish the treatable film existing on different surfaces such as the top surface, side surface and bottom surface. Further, when two or more supply units are disposed in the polishing apparatus, a plurality of treatable films existing on different surfaces can be polished in a single step.

### Embodiment 1

By using the polishing apparatus according to one embodiment of the present invention, Cu—CMP was performed according to the following procedure and the state of interface after the polishing was investigated.

FIGS. 6A and 6B are cross-sectional views each representing the steps of Cu—CMP.

First of all, an insulating film was deposited on a semiconductor substrate having semiconductor elements (not shown) formed thereon. Then, after a recessed portion was formed in the insulating film, a Cu film was deposited on the resultant surface as shown in FIG. 6A. More specifically, a W plug 22 (0.1 μm in diameter, 300 nm in thickness) was buried in the inorganic insulating film 21 (300 nm in film thickness) deposited on the semiconductor substrate 20. Further, by CVD method, a layer of LKD5109 (available from JSR) having a thickness of 100 nm was deposited as a low dielectric constant insulating film 23 and then, a layer of black diamond (available from AMAT) having a thickness of 50 nm was successively deposited as a cap film 24.

By reactive ion etching (RIE), a recessed portion (groove) A having a width ranging from 0.1 to 10 μm was formed in the low dielectric constant insulating film 23 as well as in the cap film 24. Subsequently, by sputtering method and plating method, a Ta film 25 (5 nm in thickness) and a Cu film 26 (180 nm in thickness) were successively deposited the entire surface.

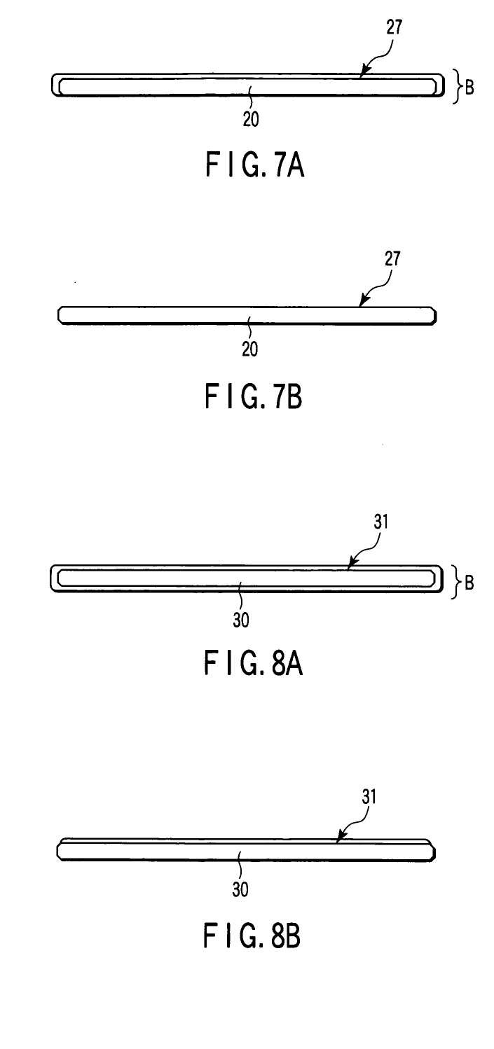

A conductive layer 27 comprising the Cu film 26 and the Ta film 25 was deposited not only on the top surface of the semiconductor substrate 20 but also on the side surface B as macroscopically shown in FIG. 7A. A redundant portion of the conductive layer 27 was removed by polishing using the polishing apparatus according to one embodiment of the present invention, to expose the surface of the cap film 24 as shown in FIG. 6B, thereby finishing the polishing as macroscopically shown in FIG. 7B.

The supply unit 12 was disposed to face the top surface and side surface of the semiconductor substrate and the polishing head 17 was contacted with the top surface of the semiconductor substrate, thus preparing the polishing apparatus of this embodiment. A polishing cloth (IC1000, Rodel Nitta Co., Ltd.) was adhered to the abrasive surface of the polishing head 17 and the load on the polishing head 17 was set to 50 gf/cm². Fumed silica having a primary particle diameter of 30 nm was dispersed in pure water at a concentration of 5 wt % to prepare a slurry. A slurry injection nozzle 13 (1.5 mm in opening diameter) was disposed at an angle of 20° to the treating surface and spaced away from the treating (polishing) surface by a distance of 10 mm. By the slurry injection nozzle 13, the slurry was injected at an injection pressure of 2 kg/cm² by using compressed air while moving the slurry injection nozzle 13 in a meandered manner at a velocity of 10 mm/sec.

Three kinds of additives, i.e. an oxidizing agent, an oxidation-suppressing agent and a surfactant were respectively sprayed from the additive supply ports 14. Specifically, a 3 wt % aqueous solution of ammonium persulfate was employed as the oxidizing agent and an aqueous solution (pH thereof was adjusted to 10 by using KOH) containing 0.3 wt % of quinaldinic acid and 0.3 wt % of quinolinic acid was employed as the oxidation-suppressing agent. Further, an aqueous solution containing 0.08 wt % of potassium dodecylbenzene sulfonate and 0.07 wt % of a fluorinated nonionic surfactant was employed as the surfactant. These additives were all fed at a flow rate of 150 cc/min.

The polishing of treating surface was performed for 120 seconds by injecting the slurry together with the supply of additives as described above while rotating the semiconductor substrate at a rotational speed of 50 rpm by a rotating mechanism. Simultaneous with this polishing, the polishing head 17 was actuated at a rocking speed of 5 mm/sec while rotating it at a rotational speed of 50 rpm.

Thereafter, pure water was fed from the pure water supply nozzle 15 to the treating surface at a flow rate of 150 cc/min to wash the semiconductor substrate. It was also possible to increase the number of supply ports so as to perform acidic washing using citric acid (0.4 wt %) for instance, thus making it possible to obtain further excellent results. After the washing, the semiconductor substrate was rotated at a rotational speed of 1000 rpm for 30 seconds to dry the semiconductor substrate.

When the state of adhesion at the interface of the films after the polishing was observed from the top of semiconductor substrate by an optical microscope, the generation of peeling was not recognized in any of the interface between the low dielectric constant insulating film 23 and the cap film 24, the interface between the cap film 24 and the Ta film 25, and the wafer edge portion. It was confirmed that by using the apparatus of this embodiment, it was possible to form Cu damascene wiring using a porous low-k film without generating peeling. Further, the erosion in the wiring having a line width of 10 μm was found to be only 27 nm, thus raising no problem.

For the purpose of comparison, the conductive layer 27 comprising the Cu film 26 and the Ta film 25 was polished by the conventional method to expose the surface of the cap film 24. More specifically, by chemical mechanical polishing (CMP) method using the ordinary polishing apparatus, the conductive layer 27 was polished by feeding thereto CMS7401, CMS7452 (both available from JSR) as a slurry and by using IC1000/SUBA400 (Rodel Nitta Co., Ltd.) as a polishing cloth. As a result, although it was possible to confine the erosion in the wiring having a line width of 10 μm to an allowable range, i.e. 28 nm, peeling was recognized at the interface between the low dielectric constant insulating film 23 and the cap film 24, the interface between the cap film 24 and the Ta film 25, or the wafer edge portion.

It was confirmed that it was possible, through the employment of the method of this embodiment, to prevent not only film peeling but also erosion.

Incidentally, in contrast to the porous low-k film, when a Cu damascene wiring is to be formed on an inorganic insulating film such as a silicon oxide film, there is little possibility of the film peeling. However, the polishing of the side surface would be required likewise. Accordingly, the polishing of the conductive layer which was deposited on the side surface of the semiconductor substrate 20 was performed herein by using a separate etching apparatus which was dedicated for the polishing of the side surface. In the employment of this special side surface etching apparatus, the etching of the side surface by using an etchant was performed while spraying air to the top surface so as to prevent the etchant from being fed to the top surface. According to the conventional method as described above, it is required to employ a separate apparatus for removing the conductive layer that has been deposited on the side surface B of the semiconductor substrate. However, according to this embodiment, it was possible to treat the side surface concurrent with the polishing of the top surface of semiconductor substrate. Therefore, it was possible to reduce the number of the polishing apparatus and to shorten the time for polishing process (e.g., treating time using a separate apparatus, a stand-by time before using a separate apparatus, etc.).

### Embodiment 2

This embodiment illustrates an example wherein the polishing of the insulating film that had been deposited on the side surface and bottom surface of semiconductor substrate was performed by using the polishing apparatus according to the embodiment of the present invention.

FIGS. 8A and 8B are cross-sectional views each illustrating macroscopically the semiconductor substrate having an insulating film deposited thereon. First of all, as shown in FIG. 8A, an LP—SiN film 31 was deposited on a semiconductor substrate 30 to a thickness of 100 nm by LP—CVD. Since the reactive gas was fed isotropically the entire surface of the semiconductor substrate 30, the SiN film 31 was deposited on the entire surface including the top surface, side surface and bottom surface of the semiconductor substrate 30 as shown in the drawing. By using the apparatus according to this embodiment, the SiN film 31 that had been deposited on the side surface and bottom surface of the substrate was selectively polished and removed without substantially polishing the SiN film 31 that had been deposited on the top surface of the semiconductor substrate 30 as shown in FIG. 8B.

The supply unit 12 was disposed to face the side surface and bottom surface of the semiconductor substrate and the polishing head 17 was contacted with the bottom surface of the semiconductor substrate, thus preparing the polishing apparatus of this embodiment. A nylon brush (25 μm in diameter) was adhered onto the surface of the polishing head 17 and the load on the polishing head 17 was set to 50 gf/cm². As an abrasive grain, fumed alumina having a primary particle diameter of 50 nm was employed as it was at a ratio of 10 wt % based on a total quantity of an aqueous solution of additives and the abrasive grain. An abrasive grain injection nozzle 13 (1.5 mm in opening diameter) was disposed at an angle of 20° to each of the treating surfaces (i.e., the side surface and the bottom surface) and spaced away from each of the treating surfaces by a distance of 5 mm. The abrasive grain injection nozzle which was disposed to face the side surface was enabled to move in the elevational direction at a velocity of 2 mm/sec, while the abrasive grain injection nozzle which was disposed to face the bottom surface was enabled to move in a meandered manner at a velocity of 10 mm/sec.

As for the additive, an aqueous solution containing 0.08 wt % of potassium dodecylbenzene sulfonate was employed. This aqueous solution employed as an additive was fed to the side surface and the bottom surface at a flow rate of 200 cc/min and 500 cc/min, respectively.

The polishing of treating surface was performed for 120 seconds by injecting the abrasive grain together with the supply of additives as described above while rotating the semiconductor substrate at a rotational speed of 50 rpm by a rotating mechanism.

Thereafter, pure water was fed from the pure water supply nozzle 15 to the treating surface to wash the semiconductor substrate. The flow rate of pure water to be fed to the side surface and the bottom surface was set to 150 cc/min and 500 cc/min, respectively. Simultaneous with this washing, the polishing head 17 was actuated at a rocking speed of 3 mm/sec while rotating it at a rotational speed of 50 rpm. It was also possible, through the employment of the brush, to effectively remove the abrasive grain as well as the erased residues generated during the polishing from the surface of the semiconductor substrate. After the washing, the semiconductor substrate was rotated at a rotational speed of 1000 rpm for 3.0 seconds to dry the semiconductor substrate.

When the state of the semiconductor substrate 30 after the polishing was observed by an SEM, a uniform deposition of SiN film 31 was recognized on the top surface and the residues of the abrasive grain were not recognized. With respect to the side surface and the bottom surface, the SiN film 31 was completely removed, thus exposing the semiconductor substrate 30, indicating excellent selective polishing between the SiN film 31 and the semiconductor substrate 30. Further, the residues of the abrasive grain were not recognized at all even on the side surface and the bottom surface. It was possible to obtain similar effects even if a wet-type slurry comprising an abrasive grain made of alumina or silica dispersed in pure water was employed.

According to this embodiment, it was possible to concurrently perform the working of the side surface and bottom surface of semiconductor substrate by using a single-unit polishing apparatus.

According to one aspect of the present invention, it is possible to provide a polishing apparatus which is capable of polishing a treatable film existing on any one of the surfaces of a semiconductor substrate. Further, according to another aspect of the present invention, it is possible to provide a method of manufacturing a semiconductor device, which is capable of working a treatable film by using a single-unit apparatus while ensuring high reliability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A polishing apparatus comprising:
a rotating mechanism which rotates a semiconductor substrate having a treatable film deposited thereon; and
a supply unit which supplies a chemical liquid to a polishing surface of the treatable film, the supply unit having an abrasive grain injection nozzle, an additive supply port, and a water supply port and being able to spray the chemical liquid onto at least one of the surfaces including the top surface, side surface, and bottom surface of the semiconductor substrate.

2. The polishing apparatus according to claim 1, wherein the supply unit is disposed to face the top surface or the bottom surface of the semiconductor substrate and arranged movable in a manner to enable a chemical liquid to be sprayed the entire top surface or the entire bottom surface of the semiconductor substrate.

3. The polishing apparatus according to claim 1, which includes at least two sets of the supply unit.

4. The polishing apparatus according to claim 1, wherein the abrasive grain injection nozzle of the supply unit has an opening diameter ranging from 0.5 to 5 mm.

5. The polishing apparatus according to claim 1, wherein the supply unit is disposed to face the top surface or the bottom surface of the semiconductor substrate, and the central axis of the abrasive grain injection nozzle is inclined at an angle ranging from 10° to 45° to a target polishing region of the polishing surface.

6. The polishing apparatus according to claim 1, wherein the supply unit is disposed to face the top surface or the bottom surface of the semiconductor substrate, and the abrasive grain injection nozzle is positioned such that the distal end thereof is spaced away from a target polishing region of the polishing surface by a distance ranging from 1 to 20 mm.

7. The polishing apparatus according to claim 1, further comprising a polishing head which assists the polishing of the polishing surface.

8. A method for manufacturing a semiconductor device comprising:
forming an insulating film above a semiconductor substrate;
forming a recessed portion in the insulating film;
depositing a conductive material in the recessed portion and on the insulating film to form a conductive layer; and
removing part of the conductive material which is deposited on the insulating film to expose the surface of the insulating film while leaving the conductive material in the recessed portion, the removal of the conductive material deposited on the insulating film being performed by using a supply unit which is provided with an abrasive grain injection nozzle, an additive supply port, and a water supply port, the supply unit being directed to face a polishing surface of the conductive layer and, while keeping the semiconductor substrate rotated, by injecting abrasive grain from the abrasive grain injection nozzle and at least an oxidizing agent from the additive supply port to the polishing surface to polish the conductive material, and by spraying water from the water supply port onto the polishing surface after finishing the polishing to wash the polishing surface.

9. The method according to claim 8, wherein the supply unit moves meanderingly over the semiconductor substrate at a velocity ranging from 1 to 20 mm/sec.

10. The method according to claim 8, wherein the abrasive grain injection nozzle injects the abrasive grain at a pressure ranging from 1 to 20 kg/cm².

11. The method according to claim 8, wherein the abrasive grain is employed by dispersing it in a dispersion medium at a concentration ranging from 0.1 to 30 wt %.

12. The method according to claim 8, wherein the abrasive grain has a primary particle diameter ranging from 10 to 1000 nm.

13. The method according to claim 8, wherein the oxidizing agent is supplied at a feeding rate ranging from 10 to 1000 cc/min.

14. The method according to claim 8, wherein the semiconductor substrate is rotated at a rotational speed ranging from 5 to 200 rpm.

15. A method for manufacturing a semiconductor device comprising:
forming an insulating film at least above a top surface and side surface of a semiconductor substrate; and
removing part of the insulating film which is deposited on a region other than the top surface of the semiconductor substrate, the removal of the insulating film being performed by using a supply unit which is provided with an abrasive grain injection nozzle, an additive supply port, and a water supply port, the supply unit being directed to face a polishing surface of the insulating film and, while keeping the semiconductor substrate rotated, by injecting abrasive grain from the abrasive grain injection nozzle and a surfactant from the additive supply port to the polishing surface to polish the insulating film, and by spraying water from the water supply port onto the polishing surface after finishing the polishing to wash the polishing surface.

16. The method according to claim 15, wherein the supply unit is positioned to face the side surface of the semiconductor substrate and moves up and down at a velocity ranging from 1 to 10 mm/sec.

17. The method according to claim 15, wherein the abrasive grain injection nozzle injects the abrasive grain at a pressure ranging from 1 to 20 kg/cm².

18. The method according to claim 15, wherein the abrasive grain has a primary particle diameter ranging from 10 to 1000 nm.

19. The method according to claim 15, wherein the surfactant is supplied at a feeding rate ranging from 10 to 1000 cc/min.

20. The method according to claim 15, wherein the semiconductor substrate is rotated at a rotational speed ranging from 5 to 200 rpm.
